(19) United States
(12) Patent Application Publication
(10) Pub. No.: US 2013/0206859 A1
(43) Pub. Date: Aug. 15, 2013

(54) LANDSCAPE WATERFALL

(71) Applicant: Richard SHERIDAN, Neptune, NJ (US)

(72) Inventor: Richard SHERIDAN, Neptune, NJ (US)

(21) Appl. No.: 13/768,612

(22) Filed: Feb. 15, 2013

Related U.S. Application Data
(60) Provisional application No. 61/599,235, filed on Feb. 15, 2012.

(51) Int. Cl. B05B 17/08

(52) U.S. Cl. CPC B05B 17/085
USPC 239/17

(57) ABSTRACT

Embodiments of the present invention generally relate to a landscape waterfall. In one embodiment, a landscape waterfall includes an extruded frame structure and a catch basin disposed adjacent the frame structure. The landscape waterfall also includes a manifold having an outlet positioned to direct water into the catch basin and a pump system configured to pump water from the catch basin to the manifold. In another embodiment, a landscape waterfall includes a plastic extruded frame structure and a housing affixed to a front side of the extruded frame structure. The landscape waterfall also includes a catch basin disposed within the housing, a manifold coupled to the frame structure, and a pump system. In yet another embodiment, a landscape waterfall assembly kit includes a pump manifold, a plastic extruded back frame, a pump system, and packaging securing the pump manifold, the plastic extruded back frame, and the pump system.

### CROSS-REFERENCE TO RELATED APPLICATION

This application claims benefit of United States Provisional Patent Application No. 61/599,235 filed Feb. 15, 2012, which is incorporated by reference in its entirety.

### BACKGROUND OF THE INVENTION

1. Field of the Invention

Embodiments of the invention generally relate to a landscape waterfall, and more specifically, a modular landscape waterfall fabricated primarily from polymer components such as PVC extrusion and the like.

2. Description of the Related Art

Traditional landscape waterfalls are fabricated from interlocking precast concrete blocks. The heavy nature of the concrete blocks prohibits prefabrication and requires a prepared foundation and significant assembly expertise in order to put together the waterfall. This results in a significantly high expense in both materials and labor required to fabricate the waterfall, along with extensive site preparation required to support the heavy weight of the precast blocks.

Thus, there is a need for an improved landscape waterfall.

### SUMMARY OF THE INVENTION

Embodiments of the present invention generally relate to a landscape waterfall fabricated primarily from polymer components which significantly reduces the weight of the landscape waterfall as compared to conventional cast block waterfalls, The landscape waterfall may be prefabricated in modular components, thereby facilitating economical shipping and rapid assembly by homeowners having little or no masonry skills.

The substantially plastic landscape waterfall being much lighter than traditional stone waterfalls may be utilized on services having little or no preparation, as the supporting surface does not have to bear the weight of conventional precast block waterfalls. The lightweight substantially plastic landscape waterfall may even be used on decking and balconies where the weight of a stone or block waterfall would be prohibited.

In one embodiment, a landscape waterfall includes an extruded frame structure and a catch basin disposed adjacent the frame structure. The landscape waterfall also includes a manifold having an outlet positioned to direct water into the catch basin and a pump system configured to pump water from the catch basin to the manifold.

In another embodiment, a landscape waterfall includes a plastic extruded frame structure and a housing affixed to a front side of the extruded frame structure. The landscape waterfall also includes a catch basin disposed within the housing, a manifold coupled to the frame structure, and a pump system. The manifold has an outlet positioned to direct water into the catch basin. The pump system is configured to pump water from the catch basin to the manifold.

In yet another embodiment, a landscape waterfall assembly kit includes a pump manifold, a plastic extruded back frame, and a pump system. The landscape waterfall assembly kit also includes packaging that secures the pump manifold, the plastic extruded back frame, and the pump system as a kit. The plastic extruded back frame is configured to support the pump manifold, and the pump system is configured to pump water to the pump manifold.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a landscape waterfall;

FIG. 2 is a front side view of the landscape waterfall of FIG. 1;

FIG. 3 is a back side view of the landscape waterfall of FIG. 1;

FIG. 4 is a left side view of the landscape waterfall of FIG. 1;

FIG. 5 is a right side view of the landscape waterfall of FIG. 1;

FIG. 6 is a top side view of the landscape waterfall of FIG. 1;

FIG. 7 is a bottom side view of the landscape waterfall of FIG. 1;

FIG. 8 is a cross-sectional view of one embodiment of a mounting bracket; and

FIG. 9 is a top view of a landscape waterfall kit.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

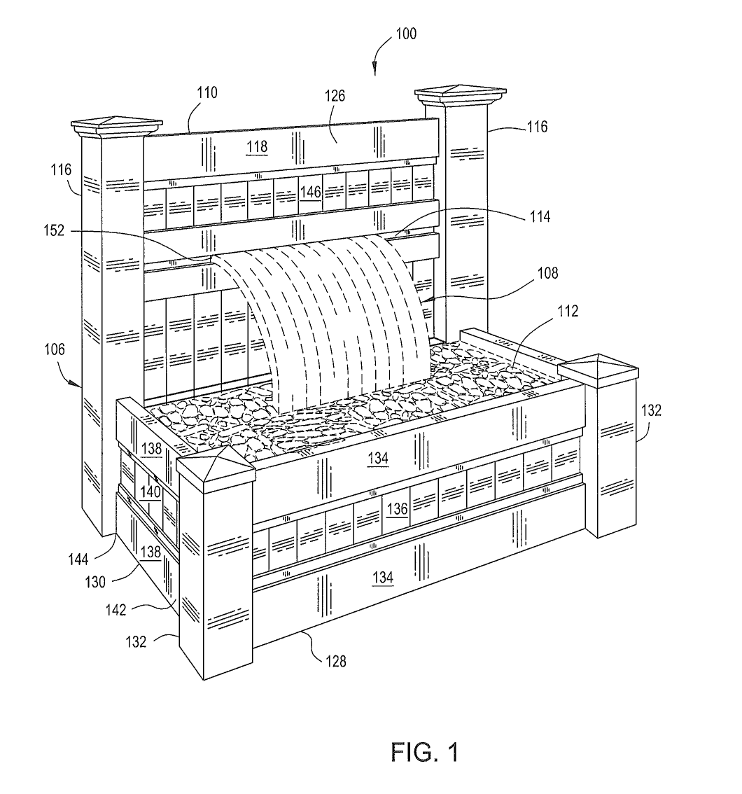

FIG. 1 is a perspective view of one embodiment of a landscape waterfall 100 of the present invention. The landscape waterfall is primarily fabricated from plastic components, thereby resulting in a significantly lighter structure as compared to the stone and block structures currently available. The landscape waterfall may be prefabricated and shipped in a shipping carton or palate for simple installation by the homeowner, or the landscape waterfall may be provided in modular form to enable rapid assembly with little difficulty.

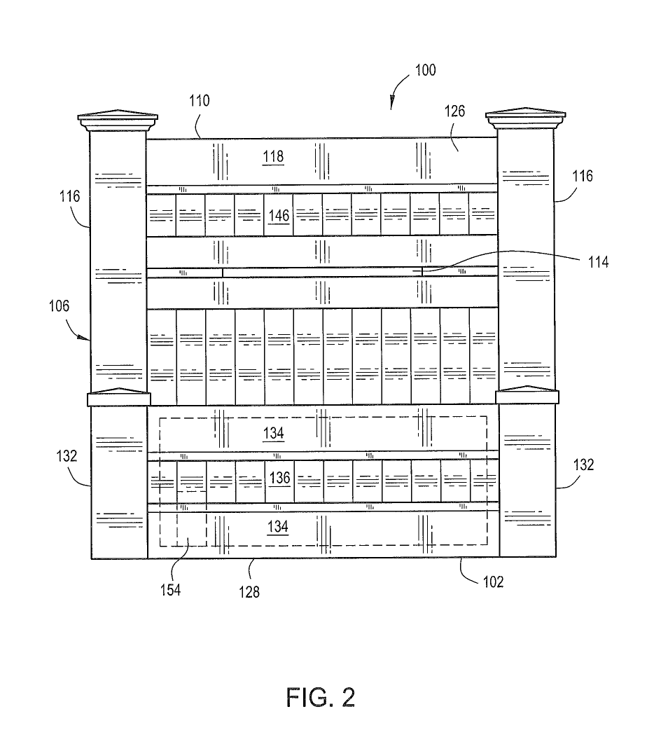

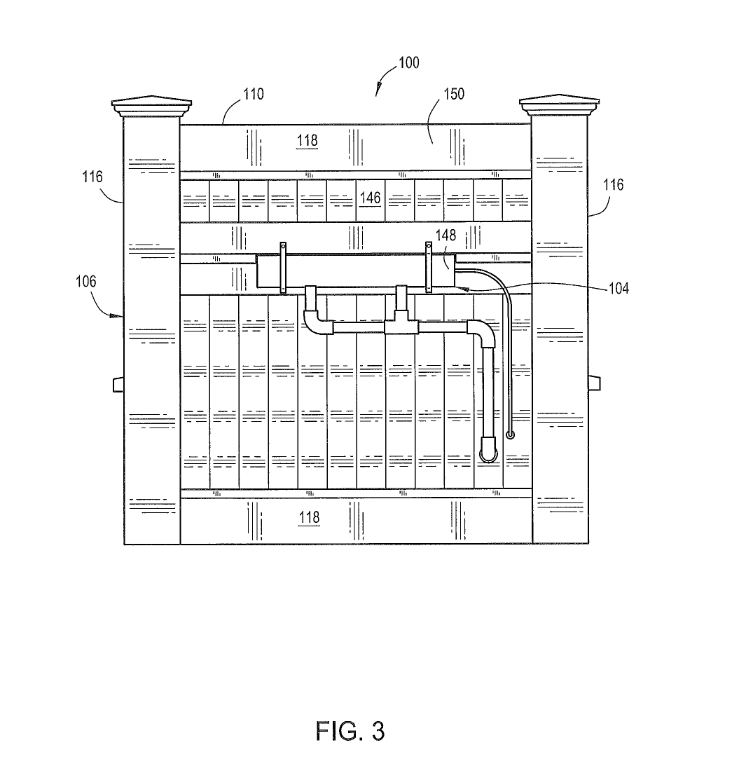

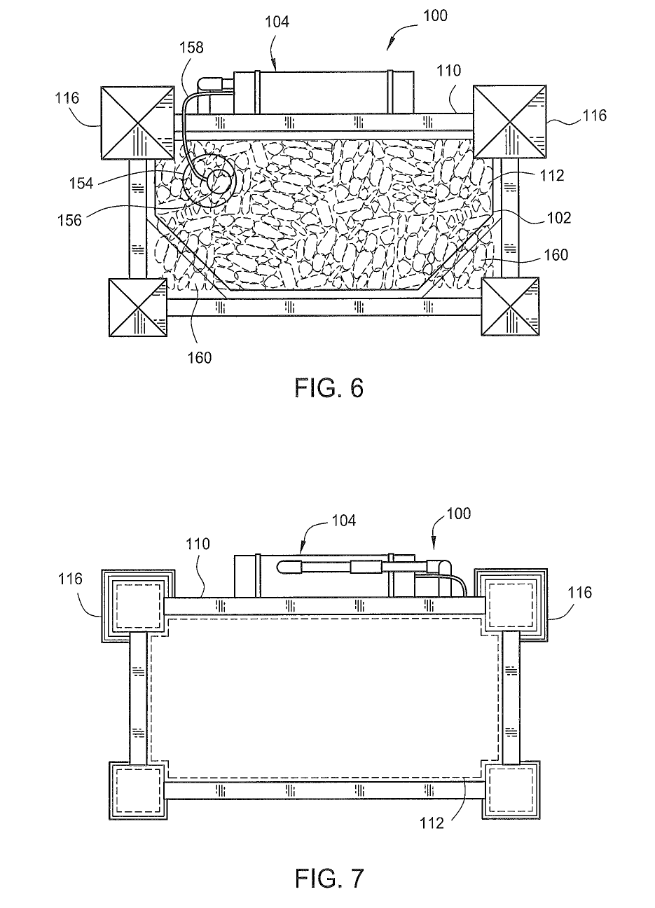

One embodiment of the landscape waterfall 100 includes a catch basin 102 (shown in phantom in FIG. 2 and shown in FIG. 6), a pump system 104 (shown in FIG. 3) and a frame structure 106. The catch basin 102 is disposed in the frame structure 106 and is utilized to hold water 108 which is pumped by the pump system 104 through the landscape waterfall 100 and back into the catch basin 102. In one embodiment, the catch basin may be disposed elsewhere adjacent the frame structure, for example in the ground, to catch the water 108 being pumped by the pump system 104.

The frame structure 106 includes a back frame 110 and an enclosure 112. The back frame 110 is a substantially vertical member having an aperture 114 formed therein through which the water 108 exiting the pump system 104 flows into the catch basin 102. In one embodiment, the aperture 114 is an elongated horizontal slot.

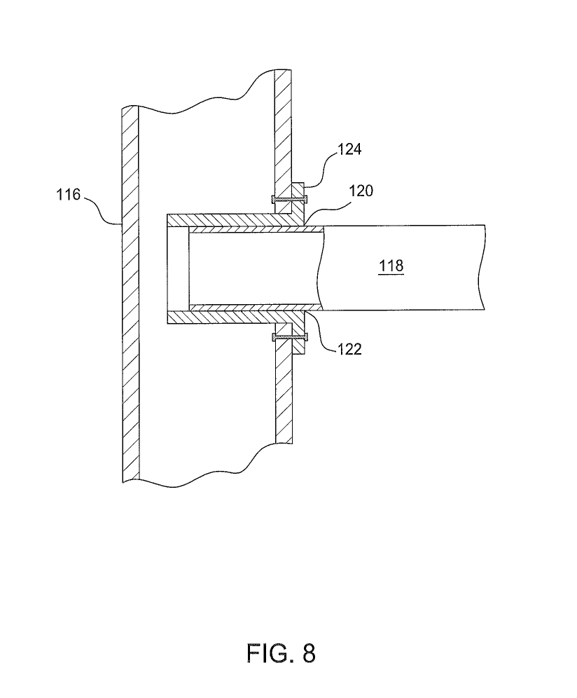

In one embodiment, the back frame 110 is fabricated from a plurality of extruded plastic forms. Suitable materials include PVC or other plastics extrudable and suitable for outdoor use. In one embodiment, the back frame 110 includes two substantially vertical posts 116 having a plurality of horizontal members 118 extending therebetween, and a back frame panel 146 disposed between the horizontal members 118. The horizontal members 118 may be fastened to the vertical posts 116 in any suitable manner, for example, the vertical post 116 may have an aperture formed therein which accepts a mounting bracket 120. As seen in FIG. 8, the mounting bracket 120 may be completely external to the vertical post 116 or extend into the vertical post 116 through a vertical post aperture 122 formed in the vertical post 116. The horizontal member 118 is inserted into the mounting bracket 120 and is secured thereto utilizing adhesive, mechanical or other suitable fastener. In one embodiment, the horizontal member 118 secured to the mounting bracket 120 using one or more fasteners 124, such as a pop rivet. In one embodiment, the vertical posts 116 and horizontal members 118 are extruded hollow plastic profiles. The back frame panel 146 is disposed between the horizontal members 118 making a substantially unitary structure. The back frame panel 146 may be fabricated from plastic, wood, fiberglass or other suitable material. In one embodiment, the back frame panel 146 is fabricated from a plurality of tongue and groove extrusions.

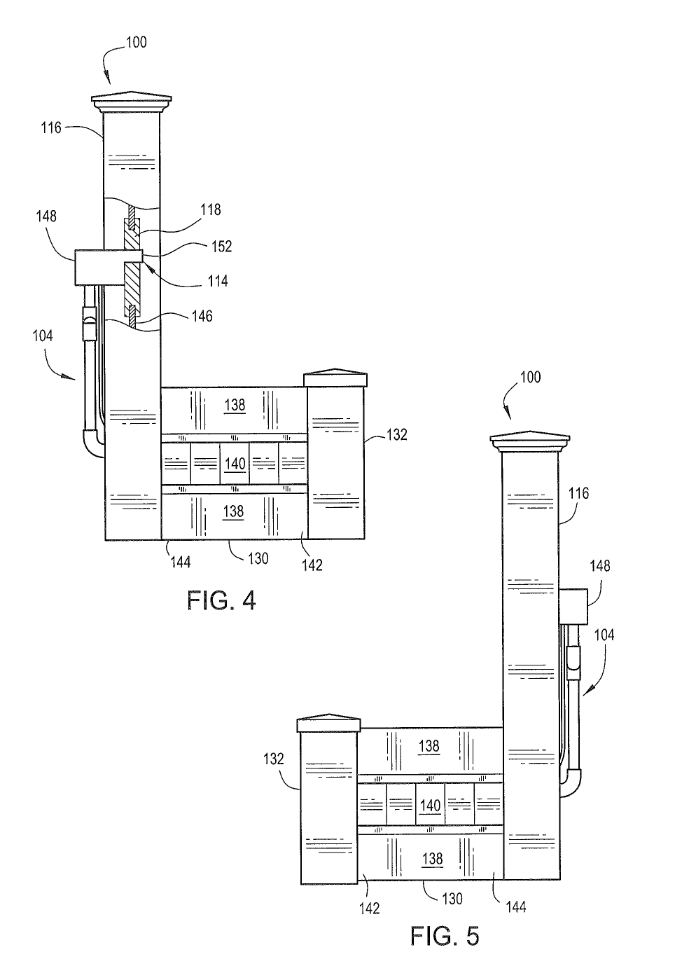

As depicted in FIG. 4, the aperture 114 may be formed through at least one of the back frame panel 146 or horizontal member 118. The aperture 114 accepts an outlet 152 of a pump manifold 148 mounted to the back side of the back frame 110. In one embodiment, the back frame 110 with pump manifold 148 mounted thereto comprises a first module of the landscape waterfall 100.

As depicted in FIG. 6, the enclosure 112 is affixed to a front side 126 of the back frame 110. The enclosure 112 may comprise one module of the landscape waterfall 100 or may comprise one or more modules of the landscape waterfall 100. In one embodiment, the enclosure 112 includes a front frame 128 coupled between two side frames 130. The front frame 128 includes a substantially vertical front frame post 132 at each end with at least one front frame horizontal member 134 extending therebetween. In the embodiment depicted in FIG. 1, two front frame horizontal members 134 are shown. The front frame horizontal members 134 may have a slot which allows a front frame panel 136 to be disposed between the front frame horizontal members 134 making a substantially rigid structure. The front frame panel 136 may be constructed in the same manner as the back frame panel 146. In one embodiment, the front frame panel 136 includes a plurality of tongue and groove plastic extrusions mated together and extending between the front frame horizontal members 134. The side frames 130 include at least two side frame horizontal members 138 having a side frame panel 140 disposed therebetween. The side frame panel 140 may be constructed the same as the back frame panel 146. The front frame posts 132 include slots which accept front ends 142 of the side frames 130, thereby facilitating fastening the side frame 130 and front frame 128 in a substantially U-shaped configuration.

Back ends of the side section 144 opposite the front section 128 are coupled to the back frame 110. The side section panels 140 may be coupled to the back frame 110 utilizing a mounting bracket as described above. The height of the back frame 110 is significantly greater than the height of the enclosure 112, for example, having a height at least one foot or more about the top of the enclosure 112 to facilitate positioning the outlet 152 of the pump manifold 148 extending through the aperture 114 above the catch basin 102 to provide the waterfall effect.

In operation, the modules comprising the front and side frames 128, 130 are coupled together and affixed to the back frame panel 146. The pump manifold 148 is mounted to a back side of the back frame panel 150 so that the outlet 152 extends or is at least aligned with the aperture 114 formed in the back frame panel 146. The catch basin 102 is set in the space defined between the enclosure 112 and the back frame panel 146, and a catch basin pump 154 is disposed in the bottom of the catch basin 102. An outlet 156 of the catch basin pump 154 is coupled to piping 158 which extends out of the catch basin through a hole formed in the back frame panel 146 to the pump manifold 148. When the catch basin 102 is filled with water 108, the pump system 104 circulates the water 108 from the catch basin 102 through the pump manifold 148 and out the aperture 114 in the back frame panel 146 in cascading a waterfall effect back into the catch basin 102. The catch basin 102 and optionally another area 160 defined between the enclosure 112 and the back frame panel 146 may be filled with rock (shown in phantom in FIG. 7) or other material to minimize splashing and to enhance the aesthetic character of the landscape waterfall 100. The pump system 104 may also be equipped with LED lights which illuminate the water 108 in one or more colors as it flows out of the pump manifold 148 and through the aperture 114 formed in the back frame panel 146.

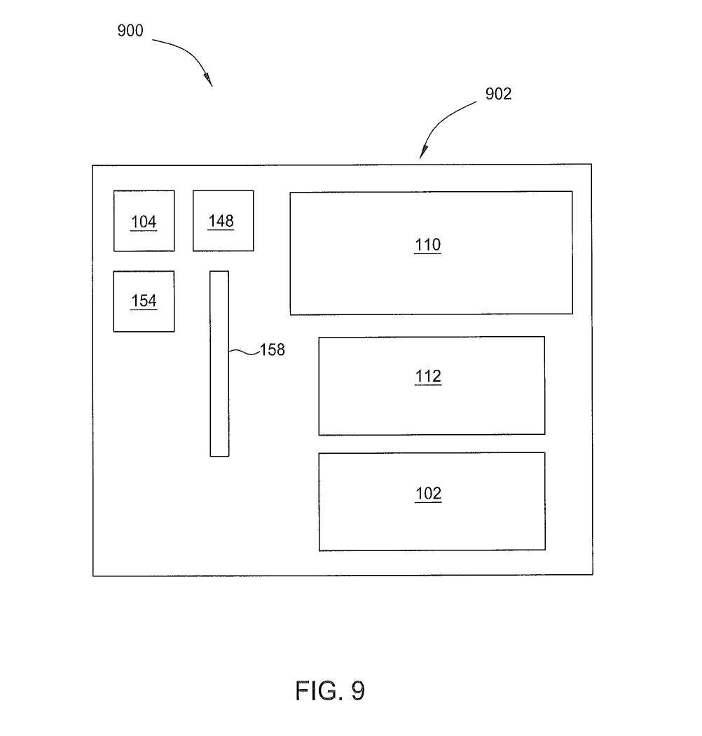

Referring to FIG. 9, the landscape waterfall 100 may be shipped in packaging 902. In one embodiment, the landscape waterfall 100 may be shipped in the packaging 902 as a kit 900 for simple installation by the homeowner, or the landscape waterfall 100 may be prefabricated into modular form to enable rapid assembly with little difficulty. The packaging 902 may be single or multiple shipping cartons, crates, bags, pallets or any other suitable single or multiple structures for securing the contents of a kit for transport during shipping or display in a store. The kit 900 may include one or more of the back frame 110, the catch basin 102, the pump system 104 and the pump manifold 148. The kit 900 may optionally include the enclosure 112, the catch basin pump 154, the piping 158 and other additional elements discussed herewithin. The kit 900 advantageously facilities economical shipping and rapid assembly by homeowners or others having little or no masonry skills.

While the foregoing is directed to embodiments of the present invention, other and further embodiments of the invention may be devised without departing from the basic scope thereof, and the scope thereof is determined by the claims that follow.

What is claimed is:

1. A landscape waterfall comprising:
an extruded frame structure;
a catch basin disposed adjacent the frame structure;
a manifold having an outlet positioned to direct water into the catch basin; and
a pump system configured to pump water from the catch basin to the manifold.

2. The landscape waterfall of claim 1, wherein the extruded frame structure comprises plastic extrusion.

3. The landscape waterfall of claim 1 further comprising a housing attached to the extruded frame structure and configured to enclose the catch basin.

4. The landscape waterfall of claim 1, wherein the extruded frame comprises a back frame disposed between two substantially vertical back frame posts, the back frame having the manifold coupled thereto.

5. The landscape waterfall of claim 4, wherein the back frame comprises a horizontal member extending between the two substantially vertical back frame posts and having an aperture formed therethrough, wherein the aperture is aligned with an outlet of the manifold to allow water to flow from the manifold into the catch basin.

6. The landscape waterfall of claim 1, wherein the aperture is an elongated horizontal slot.

7. The landscape waterfall of claim 3, wherein the housing comprises a front frame coupled between two side frames.

8. The landscape waterfall of claim 7, wherein the front frame is disposed between two substantially vertical front frame posts.

9. A landscape waterfall comprising:
a plastic extruded frame structure;
a housing affixed to a front side of the extruded frame structure;
a catch basin disposed within the housing;
a manifold coupled to the frame structure and having an outlet positioned to direct water into the catch basin; and
a pump system configured to pump water from the catch basin to the manifold.

10. The landscape waterfall of claim 9, wherein the plastic extruded frame structure comprises a back frame having two substantially vertical back frame posts and an aperture formed therein.

11. The landscape waterfall of claim 10, wherein the aperture is an elongated horizontal slot.

12. The landscape waterfall of claim 10, wherein the back frame comprises a plurality of horizontal members extending between the two substantially vertical back frame posts.

13. The landscape waterfall of claim 9, wherein the housing comprises a front frame having two substantially vertical front frame posts and coupled between two side frames.

14. The landscape waterfall of claim 13, wherein the front frame comprises a plurality of horizontal members extending between the two substantially vertical front frame posts.

15. The landscape waterfall of claim 13, wherein the two side frames comprise a plurality of horizontal members extending between the two substantially vertical front frame posts and the two substantially vertical back frame posts.

16. The landscape waterfall of claim 12, wherein the two substantially vertical back frame posts comprise an aperture to accept the plurality of horizontal members extending therebetween.

17. The landscape waterfall of claim 14, wherein the two substantially vertical front frame posts comprise an aperture to accept the plurality of horizontal members extending therebetween.

18. A landscape waterfall assembly kit comprising:
a pump manifold;
a plastic extruded back frame configured to support the pump manifold;
a pump system configured to pump water to the pump manifold; and
packaging securing the pump manifold, the back frame, and the pump system as a kit.

19. The landscape waterfall assembly kit of claim 18, further comprising:
a catch basin configured to catch water from the pump manifold.

20. The landscape waterfall assembly kit of claim 18, further comprising housing configured to attach to the plastic extruded back frame and enclose the catch basin.
